(19) United States
(12) Patent Application Publication
(10) Pub. No.: US 2018/0084965 A1
(43) Pub. Date: Mar. 29, 2018

(54) AUTOMATIC CLEANING DEVICE, AUTOMATIC CLEANING SYSTEM AND AUTOMATIC CHARGING METHOD

(71) Applicant: IBOT Robotic Co. Ltd., Taipei City (TW)

(72) Inventor: Chun-Chieh Huang, Taipei City (TW)

(73) Assignee: IBOT Robotic Co. Ltd., Taipei City (TW)

(21) Appl. No.: 15/452,745

(22) Filed: Mar. 8, 2017

(30) Foreign Application Priority Data
Sep. 23, 2016 (TW) 105130794

(51) Int. Cl. A47L 11/40; G05D 1/02

(52) U.S. Cl. CPC A47L 11/4005; A47L 11/4011; G05D 1/0225; G05D 1/0242; A47L 2201/04; G05D 1/0259; G05D 1/0255; A47L 2201/022; G05D 1/0236

(57) ABSTRACT

An automatic cleaning device includes a main body and a sensor. The main body includes a charging unit and a battery unit. The charging unit is arranged on a side of the main body. The automatic cleaning device is configured to decide whether to enter an auto charging mode, so as to sequentially perform a walking-along-the-wall operation and a reset charging operation. During the walking-along-the-wall operation of the automatic cleaning device, when the sensor senses a signal, the automatic cleaning device stops the walking-along-the-wall operation, and performs the reset charging operation after the main body turns a preset angle. During the reset charging operation of the automatic cleaning device, after the main body moves to the charging base, whether the charging unit contacts a charging base is determined, so as to charge the battery unit.

### CROSS-REFERENCE TO RELATED APPLICATION

This application claims the priority benefit of Taiwan application serial no. 105130794, filed on Sep. 23, 2016. The entirety of the above-mentioned patent application is hereby incorporated by reference herein and made a part of this specification.

### BACKGROUND OF THE INVENTION

### Field of the Invention

The invention relates to a cleaning technique, particularly to an automatic cleaning device, an automatic cleaning system and an automatic charging method.

### Description of Related Art

In the technical field of automatic cleaning devices, an increasing number of studies and designs are directed to enhancing usability of an automatic cleaning device by equipping the automatic cleaning device with an automatic charging function. However, if the automatic cleaning device cannot have its main body return to a charging base via an effective moving path, the capability of the automatic cleaning device to operate continuously for a long time may be affected, and the cleaning effect thereof may even be reduced. Therefore, how to design an automatic cleaning device which efficiently performs an automatic reset charging operation so as to accurately locate a charging base for charging itself is currently an important subject.

### SUMMARY OF THE INVENTION

The invention provides an automatic cleaning device, an automatic cleaning system and an automatic charging method which efficiently perform an automatic reset charging operation, enabling the automatic cleaning device to accurately locate a charging base for performing automatic charging.

The automatic cleaning device of the invention includes a main body and a sensor. The main body includes a charging unit and a battery unit. The charging unit is arranged on a side of the main body. The charging unit is coupled to the battery unit. The automatic cleaning device is configured to decide whether to enter an auto charging mode, so as to sequentially perform a walking-along-the-wall operation and a reset charging operation. The sensor is arranged on a lateral side of the main body. The sensor is configured to sense a signal. During the walking-along-the-wall operation of the automatic cleaning device, when the sensor senses a signal, the automatic cleaning device stops the walking-along-the-wall operation, and performs the reset charging operation after the main body turns a preset angle. During the reset charging operation of the automatic cleaning device, the main body moves to the charging base, and the automatic cleaning device determines whether the charging unit contacts a charging base, so as to charge the battery unit.

In an embodiment of the invention, during the reset charging operation, when the automatic cleaning device determines that the charging unit does not contact the charging base, the automatic cleaning device stops the reset charging operation, and resumes the reset charging operation after the main body turns left and right.

In an embodiment of the invention, the automatic cleaning device performs the reset charging operation at most a preset number of times to sense at most the preset number of times whether the charging unit contacts the charging base, so as to decide whether to perform again the walking-along-the-wall operation.

In an embodiment of the invention, the preset number of times is four.

In an embodiment of the invention, during the walking-along-the-wall operation of the automatic cleaning device, the main body moves forward in a random direction until contacting a wall surface, so that the main body walks along the wall surface.

In an embodiment of the invention, the sensor is an infrared sensor, an ultrasonic sensor, a magnetic sensor or a laser sensor.

The automatic cleaning system of the invention includes a charging base and an automatic cleaning device. The charging base is disposed on a wall surface and includes a power supply unit and a signal emitter. The automatic cleaning device includes a main body and a sensor. The main body includes a charging unit and a battery unit. The charging unit is arranged on a side of the main body. The charging unit is coupled to the battery unit. The automatic cleaning device is configured to decide whether to enter an auto charging mode, so as to sequentially perform a walking-along-the-wall operation and a reset charging operation. The sensor is arranged on a lateral side of the main body. The sensor is configured to sense a signal provided by the signal emitter. During the walking-along-the-wall operation of the automatic cleaning device, when the sensor senses the signal, the automatic cleaning device stops the walking-along-the-wall operation, and performs the reset charging operation after the main body turns a preset angle. During the reset charging operation of the automatic cleaning device, after the main body moves to the charging base, the automatic cleaning device determines whether the charging unit contacts the power supply unit of the charging base, so as to charge the battery unit.

In an embodiment of the invention, during the reset charging operation, when the automatic cleaning device determines that the charging unit does not contact the charging base, the automatic cleaning device stops the reset charging operation, and resumes the reset charging operation after turning the main body left and right.

In an embodiment of the invention, the automatic cleaning device performs the reset charging operation at most a preset number of times to determine at most the preset number of times whether the charging unit contacts the power supply unit of the charging base, so as to decide whether to perform again the walking-along-the-wall operation.

In an embodiment of the invention, the preset number of times is four.

In an embodiment of the invention, during the walking-along-the-wall operation of the automatic cleaning device, the main body moves forward in a random direction until contacting the wall surface, so that the main body walks along the wall surface.

In an embodiment of the invention, the sensor is an infrared sensor, an ultrasonic sensor, a magnetic sensor or a laser sensor. The signal emitter is an infrared emitter, an ultrasonic emitter, a magnetic emitter or a laser emitter.

The automatic charging method of the invention is suitable for an automatic cleaning device. The automatic cleaning device includes a main body, the main body including a charging unit, a battery unit and a sensor. The sensor is configured to sense a signal. The automatic charging method includes the following steps. Configuring to decide whether the automatic cleaning device enter an auto charging mode so as to sequentially perform a walking-along-the-wall operation and a reset charging operation. During the walking-along-the-wall operation of the automatic cleaning device, when the sensor senses a signal, the walking-along-the-wall operation is stopped, and the reset charging operation is performed after the main body turns a preset angle. During the reset charging operation of the automatic cleaning device, after the main body moves to the charging base, whether the charging unit contacts a charging base is determined, so as to charge the battery unit.

In an embodiment of the invention, the step of determining, during the reset charging operation of the automatic cleaning device and after the main body moves to the charging base, whether the charging unit contacts the charging base so as to charge the battery unit, includes the following steps. During the reset charging operation, when the automatic cleaning device senses that the charging unit does not contact the charging base, the reset charging operation is stopped, and the reset charging operation is resumed after the main body turns left and right.

In an embodiment of the invention, the automatic cleaning device performs the reset charging operation at most a preset number of times to determine at most the preset number of times whether the charging unit contacts the charging base, so as to decide whether to perform again the walking-along-the-wall operation.

In an embodiment of the invention, the preset number of times is four.

In an embodiment of the invention, during the walking-along-the-wall operation of the automatic cleaning device, the main body moves forward in a random direction until contacting a wall surface, so that the main body walks along the wall surface.

In an embodiment of the invention, the sensor is an infrared sensor, an ultrasonic sensor, a magnetic sensor or a laser sensor.

Based on the above, the automatic cleaning device of the embodiments of the invention locates the charging base by the walking-along-the-wall operation, and, by the reset charging operation, makes the charging unit of the main body contact the charging base so as to charge the battery unit. Moreover, the automatic cleaning device of the embodiments of the invention senses the signal by the sensor, so as to decide whether to stop the walking-along-the-wall operation and to sequentially perform the reset charging operation.

To make the above features and advantages of the invention more comprehensible, several embodiments accompanied with drawings are described in detail as follows.

### BRIEF DESCRIPTION OF THE DRAWINGS

FIG. 1 is a schematic view showing an automatic cleaning system according to an embodiment of the invention.

FIG. 2 is a schematic view showing an automatic cleaning device and a charging base according to an embodiment of the invention.

FIG. 3 is a schematic view showing a charging base according to an embodiment of the invention.

FIG. 4 is a flowchart showing steps of a walking-along-the-wall operation and a reset charging operation according to an embodiment of the invention.

FIG. 5 is a schematic view showing that the automatic cleaning device performs the walking-along-the-wall operation according to an embodiment of the invention.

FIG. 6 is a schematic view showing that the automatic cleaning device performs the reset charging operation according to an embodiment of the invention.

FIG. 7 is a schematic view showing that the automatic cleaning device turns its main body left and right according to an embodiment of the invention.

FIG. 8 is a flowchart showing steps of an automatic charging method according to an embodiment of the invention.

### DETAILED DESCRIPTION OF DISCLOSED EMBODIMENTS

The term “coupled” used in this specification (including claims) may refer to any direct or indirect connection means. For example, “a first device is coupled to a second device” should be interpreted as “the first device is directly coupled to the second device” or “the first device is indirectly coupled to the second device through other devices, guide wires or certain connection means.” Moreover, wherever appropriate in the drawings and embodiments, elements/components/steps with the same reference numerals represent the same or similar parts. Elements/components/steps with the same reference numerals or names in different embodiments may be cross-referenced.

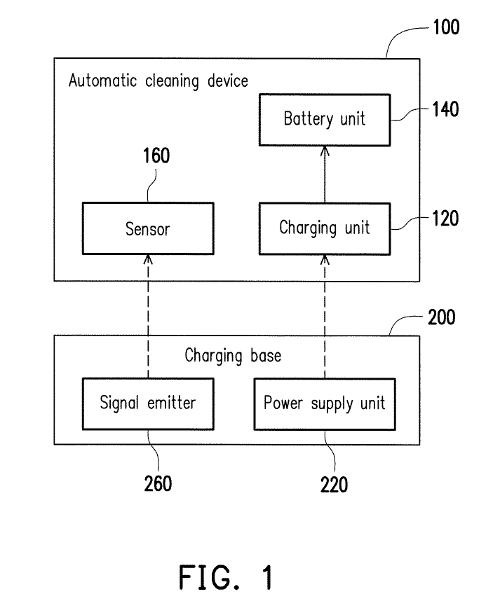

FIG. 1 is a schematic view showing an automatic cleaning system according to an embodiment of the invention. Referring to FIG. 1, an automatic cleaning system includes an automatic cleaning device 100 and a charging base 200. The automatic cleaning device 100 includes a charging unit 120, a battery unit 140 and a sensor 160. The charging unit 120 is coupled to the battery unit 140. The charging unit 120 is configured to receive an external charging voltage and provide it to the battery unit 140, thereby charging the battery unit 140. The charging base 200 includes a power supply unit 220 and a signal emitter 260. In the present embodiment, the charging unit 120 of the automatic cleaning device 100 receives a charging voltage from the power supply unit 220 of the charging base 200, so as to charge the battery unit 140. The sensor 160 of the automatic cleaning device 100 is configured to sense a signal provided by the signal emitter 260 of the charging base 200.

In the present embodiment, the battery unit 140 is, for example, a rechargeable battery such as a lithium battery, a nickel-metal hydride battery or the like. The automatic cleaning device 100 is configured to decide whether to enter an auto charging mode. The automatic cleaning device 100 may decide whether to enter an auto charging mode according to the setting or control of the user. For example, the automatic cleaning device 100 may sense whether an electrical quantity of the battery unit 140 is lower than a preset electrical quantity to decide whether to enter an auto charging mode, so as to sequentially perform a walking-along-the-wall operation and a reset charging operation. However, the preset electrical quantity in the present embodiment may be designed correspondingly based on different types of battery units, degree of power consumption of the automatic cleaning device, or user needs. For example, in an embodiment, the preset electrical quantity may be 10%, 15% or 20% of the total electrical quantity of the battery unit 140.

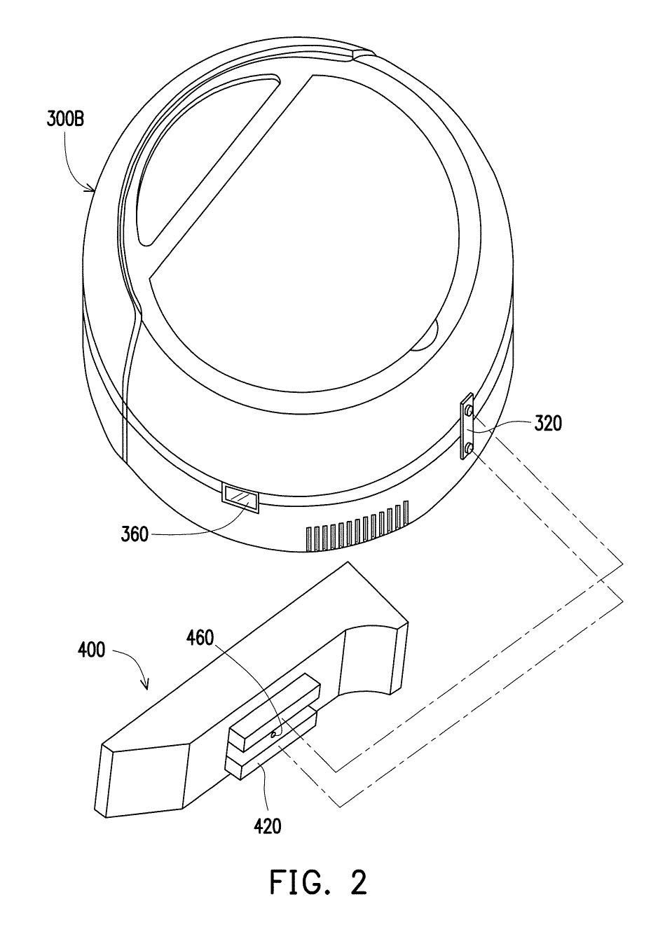

In the present embodiment, the sensor 160 maybe an infrared sensor, an ultrasonic sensor, a magnetic sensor or a laser sensor. The signal emitter 260 maybe an infrared emitter, an ultrasonic emitter, a magnetic emitter or a laser emitter. Take the infrared sensor and the infrared emitter as an example. The sensor 160 may sense an infrared signal emitted by the signal emitter 260. In the present embodiment, according to whether the sensor 160 has sensed an infrared signal emitted by the signal emitter 260, the automatic cleaning device 100 decides whether to stop the walking-along-the-wall operation and to sequentially perform the reset charging operation. Details of the walking-along-the-wall operation and the reset charging operation will be described in the following embodiments as shown in FIGS. 2 to 8.

In the present embodiment, the automatic cleaning device 100 is a cleaning robot. That is, the automatic cleaning device 100 includes a cleaning module and a power module. When the automatic cleaning device 100 enters an auto cleaning mode, the automatic cleaning device 100 automatically walks on the floor by the power module and cleans the floor by the cleaning module. For example, the power module includes a motor and a wheel. The power module drives the wheel by electric power provided by the battery unit 140, so as to enable the automatic cleaning device 100 to walk on the floor. Moreover, the power module also drives the cleaning module to make its cleaning tool perform a cleaning operation such as rotating, swinging and so on. However, detailed technical features of the cleaning module and the power module of the present embodiment are sufficiently taught, suggested, and embodied based on ordinary skill in the art and will thus be omitted herein.

In addition, the automatic cleaning device 100 of the present embodiment further includes a control circuit. The control circuit is coupled to the charging unit 120, the battery unit 140 and the sensor 160. The control circuit is, for example, a central processing unit (CPU), a microprocessor unit (MPU) or a micro control unit (MCU) or the like, and the invention is not limited thereto. The control circuit at least implements an automatic charging method as described in the invention by a program as software or a logic circuit as hardware.

FIG. 2 is a schematic view showing an automatic cleaning device and a charging base according to an embodiment of the invention. Referring to FIG. 2, the automatic cleaning device of the invention may be as shown in FIG. 2. The automatic cleaning device includes a main body 300B, a charging unit 320 and a sensor 360. A battery unit is arranged inside the main body 300B. In the present embodiment, the charging unit 320 is arranged on a side of the main body 300B, and the sensor 360 is arranged on a lateral side of the main body 300B. In the present embodiment, the charging unit 320 is arranged on a rear side of the plain body 300B, but the invention is not limited thereto. In one embodiment, the charging unit 320 may also be arranged on a front side, so that the automatic cleaning device may move the main body 300B forward to charge. In the present embodiment, the charging unit 320 has positive and negative electrode terminals configured to contact positive and negative electrode terminals respectively of a power supply unit 420, so as to electrically connect the charging unit 320 to the power supply unit 420. That is, the charging unit 320 may be combined with the power supply unit 420 of a charging base 400, so that the charging unit 320 receives a charging signal (hereinafter charging voltage), such as charging voltage, charging current, or charging pulse or the like, provided by the power supply unit 420. Moreover, in the present embodiment, a signal emitter 460 may be arranged in the same position as that of the power supply unit 420. When the main body 300B moves into a range covered by a signal provided by the signal emitter 460, and the sensor 360 of the main body 300B receives the signal provided by the signal emitter 460, the main body 300B turns in situ a preset angle, so as to align the charging unit 320 with the power supply unit 420.

In addition, the position in which the sensor 360 is arranged is not limited to the one side of the main body 300B as shown in FIG. 2. In an embodiment, the sensor 360 may be arranged on the other side of the main body 300B. Moreover, the charging unit 320 and the sensor 360 may be arranged in the same or different horizontal lines, and the invention is not limited thereto.

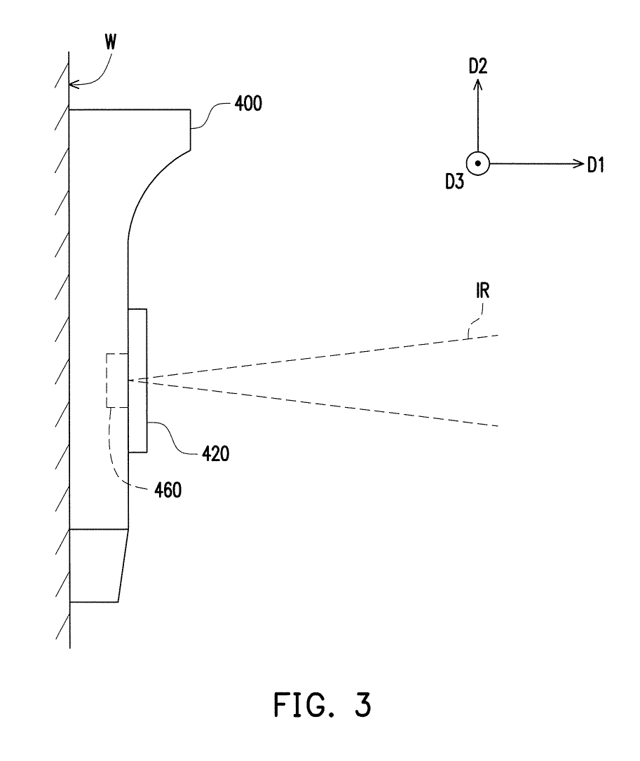

Specifically, FIG. 3 is a schematic view showing a charging base according to an embodiment of the invention. Referring to FIG. 3, a plane formed by a first direction D1 and a second direction D2 represents a floor surface, and a plane formed by the second direction D2 and a third direction D3 represents a wall surface W, wherein the first direction D1, the second direction D2 and the third direction D3 are perpendicular to one another. Take an infrared sensor and an infrared emitter as an example. In the present embodiment, the charging base 400 is disposed on the wall surface W, the signal emitter 460 and the power supply unit 420 of the charging base 400 are arranged in the same position, and the signal emitter 460 emits in the first direction D1 a signal IR having a divergence angle. In the present embodiment, the signal IR is an infrared signal, but the invention is not limited thereto. In one embodiment, the signal IR may also be an ultrasonic signal, a magnetic signal or a laser signal. That is, the automatic cleaning device walks on the plane as the floor surface formed by the first direction D1 and the second direction D2, and when the automatic cleaning device moves into an emission range of the signal IR, the sensor of the automatic cleaning device senses the signal IR. However, the divergence angle of the signal IR is determined by the design of the signal emitter 460, and may be, for example, 10 degrees, 20 degrees, 30 degrees or 40 degrees. The invention is not limited thereto.

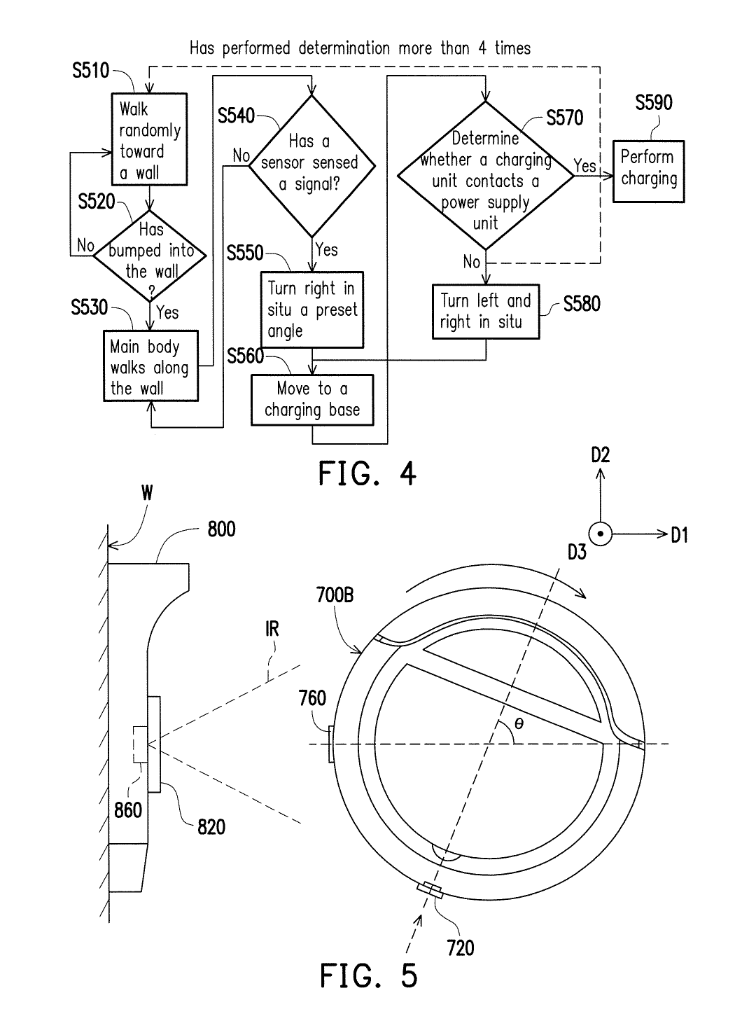

FIG. 4 is a flowchart showing steps of a walking-along-the-wall operation and a reset charging operation according to an embodiment of the invention. FIGS. 5 to 7 are schematic views showing that the automatic cleaning device performs the walking-along-the-wall operation and the reset charging operation according to an embodiment of the invention. Take a charging unit 720 is arranged on a rear side of the main body 700B as an example. Referring first to FIGS. 4 and 5, the automatic cleaning device determines whether to enter an auto charging mode. For example, when the automatic cleaning device senses that an electrical quantity of a battery unit is lower than a preset electrical quantity, the automatic cleaning device performs the walking-along-the-wall operation. In step S510, a main body 700B walks randomly toward a wall in a random direction. In step S520, the automatic cleaning device determines whether the main body 700B has bumped into the wall. If no, the main body 700B continues to walk randomly toward the wall. If yes, in step S530, after the main body 700B contacts the wall surface W, the main body 700B walks along the wall. That is, the main body 700B moves alongside the wall surface W, so as to locate a charging base 800. In step S540, the automatic cleaning device determines whether a sensor 760 has sensed the signal IR emitted by a signal emitter 860 of the charging base 800. If no, the main body 700B of the automatic cleaning device continues to walk along the wall. If yes, in step S550, the main body 700B turns right in situ a preset angle θ so as to align the charging unit 720 with a power supply unit 820.

It is worth noting that the preset angle θ that the main body 700B turns may be determined based on an angle between a walking direction of the automatic cleaning device and the wall surface W or based on a position in which the sensor 760 is arranged on the main body 700B. The invention is not limited thereto. In the present embodiment, the walking direction of the automatic cleaning device may be parallel or non-parallel to the wall surface W, and the sensor 760 may be arranged in any position on a lateral side of the main body 700B. Thus, in an embodiment, the preset angle θ that the main body 700B turns is, for example, 80 degrees, 90 degrees or 100 degrees, or is between 60 to 120 degrees. In addition, the walking-along-the-wall operation in the present embodiment means that the automatic cleaning device walks alongside the wall surface W, wherein the automatic cleaning device may walk in a straight line parallel to the wall surface W or may walk in a zigzag manner non-parallel to the wall surface W. The invention is not limited thereto. The manner and path in which the automatic cleaning device walks along the wall are sufficiently taught, suggested, and embodied based on ordinary skill in the art and will thus be omitted herein.

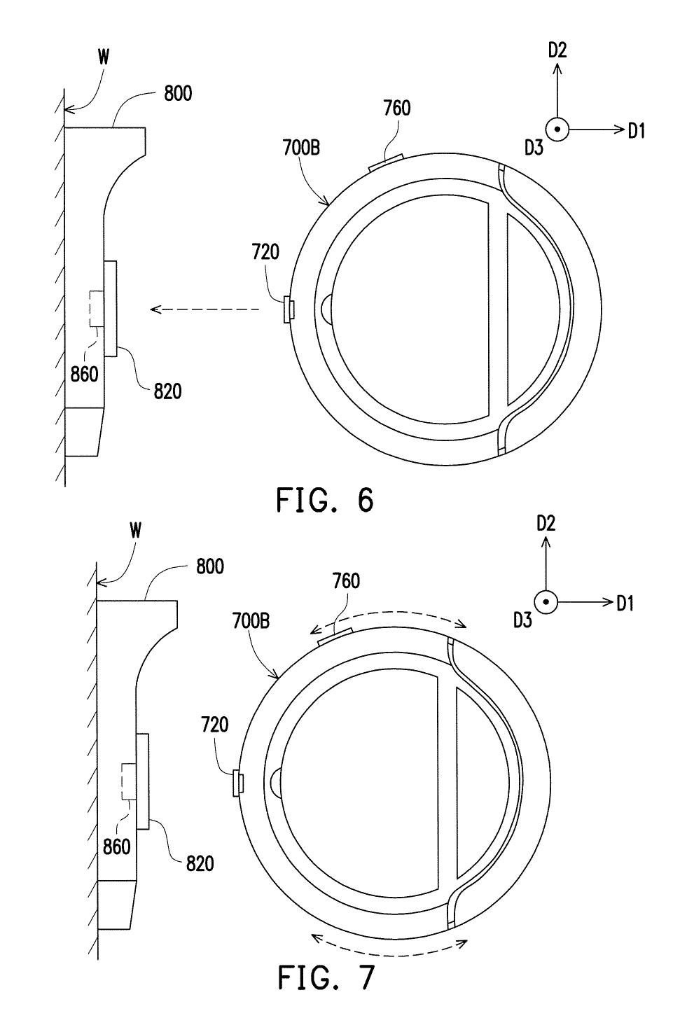

Then, referring to FIGS. 4 and 6, after the automatic cleaning device turns the main body 700B the preset angle θ, the automatic cleaning device sequentially performs a reset charging operation. In step S560, the main body 700B moves to the charging base 800. In step S570, the automatic cleaning device determines whether the charging unit 720 contacts the power supply unit 820. If yes, in step S590, the automatic cleaning device fixes the position of the main body 700B, and the charging unit 720 receives a charging voltage from the power supply unit 820, so as to charge the battery unit of the automatic cleaning device.

It is worth noting that, in the present embodiment, the signal IR emitted by the signal emitter 860 has a divergence angle, and the power supply unit 820 of the charging base 800 has a larger contact area. Accordingly, the automatic cleaning device of the present embodiment performs positioning by the arrangement of the single sensor 760 on the main body 700B. That is, even if the charging unit 720 is not completely aligned with the power supply unit 820 after the main body 700B has moved to the charging base 800, by designing the power supply unit 820 to have a larger contact area, the charging unit 720 may still contact the power supply unit 820 in a tolerable range.

Then, referring to FIGS. 4 and 7, when the automatic cleaning device determines that the charging unit 720 does not contact the power supply unit 820 of the charging base 800, the automatic cleaning device stops the reset charging operation and performs step S580. In step S580, the main body 700B turns left and right in situ so as to randomly fine-tune its orientation. Next, steps S560 and S570 are again performed, in which the main body 700B moves to the charging base 800 and whether the charging unit 720 contacts the power supply unit 820 is again determined.

It is worth noting that, in the present embodiment, the automatic cleaning device may perform the reset charging operation in steps S560 and S570 at most a preset number of times to sense at most the preset number of times whether the charging unit contacts the charging base, so as to decide whether to perform again the walking-along-the-wall operation in steps S510, S520 and S530. In an embodiment, the preset number of times is four. That is, the automatic cleaning device may perform the determination operation at most 4 times. After the main body 700B has fine-tuned its orientation by turning left and right and has moved to the charging base 800, if the charging unit 720 of the main body 700B still cannot contact the power supply unit 820 of the charging base 800, it means that the automatic cleaning device cannot be effectively aligned with the charging base 800, or that the main body 700B has deviated from the charging base 800. Accordingly, the automatic cleaning device performs again the walking-along-the-wall operation so as to locate the charging base 800 again.

However, FIGS. 5 to 7 only serve to illustrate an exemplary embodiment of the invention, and the walking manner of the automatic cleaning device of the invention is not limited to those shown in FIGS. 5 to 7.

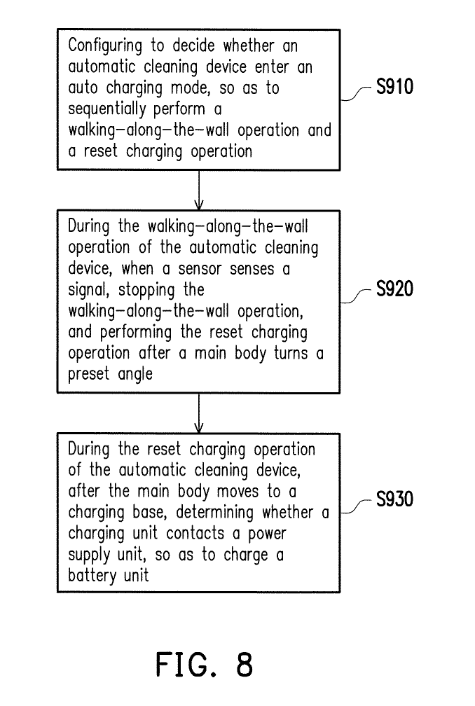

FIG. 8 is a flowchart showing steps of an automatic charging method according to an embodiment of the invention. Referring to FIGS. 5 to 8, the method of the present embodiment is at least applicable to the automatic cleaning device shown in FIGS. 5 to 7. The automatic cleaning device includes the main body 700B. The main body 700B includes the charging unit 720 and the sensor 760, and a battery unit is disposed inside the main body 700B. The sensor 760 is configured to sense a signal provided by the light emitter 860 of the charging base 800. In step S910, the automatic cleaning device is configured to decide whether to enter an auto charging mode so as to sequentially perform a walking-along-the-wall operation and a reset charging operation. In step S920, during the walking-along-the-wall operation of the automatic cleaning device, when the sensor 760 senses a signal, the automatic cleaning device stops the walking-along-the-wall operation, and performs the reset charging operation after the main body 700B of the automatic cleaning device turns a preset angle. In step S930, during the reset charging operation of the automatic cleaning device, after the main body 700B moves to the charging base, whether the charging unit 720 contacts the power supply unit 820 of the charging base 800 is determined, so that the charging unit 720 receives a charging voltage from the power supply unit 820 of the charging base 800, so as to charge the battery unit. Therefore, by the automatic charging method of the present embodiment, the automatic cleaning device, when having insufficient electrical quantity, is capable of accurately and automatically locating a charging base for charging itself.

In addition, operation details and technical features of the automatic charging method of the present embodiment are sufficiently taught, suggested, and embodied based on the descriptions of the embodiments shown in FIGS. 1 to 7, and will thus be omitted herein.

In summary, in the exemplary embodiments of the invention, the automatic cleaning device is designed to have an auto charging mode, so that when the automatic cleaning device decides to enter an auto charging, the automatic cleaning device performs the walking-along-the-wall operation and the reset charging operation. In the exemplary embodiments of the invention, the automatic cleaning device first performs the walking-along-the-wall operation, and then performs the reset charging operation. Based on a sensing result of the sensor, the automatic cleaning device determines whether the main body has moved in front of the charging base, so that the automatic cleaning device stops the walking-along-the-wall operation and sequentially performs the reset charging operation. In addition, in the exemplary embodiments of the invention, the automatic cleaning device is further designed to perform determination at most a preset number of times. When the number of times the automatic cleaning device determines whether the charging unit contacts the charging base exceeds the preset number of times, the automatic cleaning device performs again the walking-along-the-wall operation so as to search again for the charging base and align therewith. That is, the automatic cleaning device avoids continuously performing a null reset charging operation by a determination loop. Accordingly, the automatic cleaning device, automatic cleaning system and automatic charging method of the exemplary embodiments of the invention perform an efficient automatic reset charging operation, enabling the automatic cleaning device to accurately locate the charging base for performing automatic charging.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An automatic cleaning device, comprising:
a main body comprising a charging unit and a battery unit, wherein the charging unit is arranged on a side of the main body and is coupled to the battery unit, wherein the automatic cleaning device is configured to decide whether to enter an auto charging mode, so as to sequentially perform a walking-along-the-wall operation and a reset charging operation; and
a sensor arranged on a lateral side of the main body and configured to sense a signal,
wherein during the walking-along-the-wall operation of the automatic cleaning device, when the sensor senses the signal, the automatic cleaning device stops the walking-along-the-wall operation, and performs the reset charging operation after the main body turns a preset angle, and
wherein during the reset charging operation of the automatic cleaning device, the main body moves to the charging base, and the automatic cleaning device determines whether the charging unit contacts a charging base, so as to charge the battery unit.

2. The automatic cleaning device according to claim 1, wherein during the reset charging operation, when the automatic cleaning device determines that the charging unit does not contact the charging base, the automatic cleaning device stops the reset charging operation, and resumes the reset charging operation after the main body turns left and right.

3. The automatic cleaning device according to claim 2, wherein the automatic cleaning device performs the reset charging operation at most a preset number of times to sense at most the preset number of times whether the charging unit contacts the charging base, so that the automatic cleaning device decides whether to perform again the walking-along-the-wall operation.

4. The automatic cleaning device according to claim 3, wherein the preset number of times is four.

5. The automatic cleaning device according to claim 1, wherein during the walking-along-the-wall operation of the automatic cleaning device, the main body moves forward in a random direction until contacting a wall surface, so that the main body walks along the wall surface.

6. The automatic cleaning device according to claim 1, wherein the sensor is an infrared sensor, an ultrasonic sensor, a magnetic sensor or a laser sensor.

7. An automatic cleaning system, comprising:
a charging base disposed on a wall surface and comprising a power supply unit and a signal emitter; and
an automatic cleaning device comprising:
a main body comprising a charging unit and a battery unit, wherein the charging unit is arranged on a side of the main body and is coupled to the battery unit, wherein the automatic cleaning device is configured to decide whether to enter an auto charging mode so as to sequentially perform a walking-along-the-wall operation and a reset charging operation; and
a sensor arranged on a lateral side of the main body and configured to sense a signal provided by the signal emitter,
wherein during the walking-along-the-wall operation of the automatic cleaning device, when the sensor senses the signal, the automatic cleaning device stops the walking-along-the-wall operation, and performs the reset charging operation after the main body turns a preset angle, and
wherein during the reset charging operation of the automatic cleaning device, after the main body moves to the charging base, the automatic cleaning device determines whether the charging unit contacts the power supply unit of the charging base, so as to charge the battery unit.

8. The automatic cleaning system according to claim 7, wherein during the reset charging operation, when the automatic cleaning device determines that the charging unit does not contact the charging base, the automatic cleaning device stops the reset charging operation, and resumes the reset charging operation after turning the main body left and right.

9. The automatic cleaning system according to claim 8, wherein the automatic cleaning device performs the reset charging operation at most a preset number of times to determine at most the preset number of times whether the charging unit contacts the power supply unit of the charging base, so that the automatic cleaning device decides whether to perform again the walking-along-the-wall operation.

10. The automatic cleaning system according to claim 9, wherein the preset number of times is four.

11. The automatic cleaning system according to claim 7, wherein during the walking-along-the-wall operation of the automatic cleaning device, the main body moves forward in a random direction until contacting the wall surface, so that the main body walks along the wall surface.

12. The automatic cleaning system according to claim 7, wherein the sensor is an infrared sensor, an ultrasonic sensor, a magnetic sensor or a laser sensor, and the signal emitter is an infrared emitter, an ultrasonic emitter, a magnetic emitter or a laser emitter.

13. An automatic charging method suitable for an automatic cleaning device, wherein the automatic cleaning device comprises a main body, the main body comprising a charging unit, a battery unit and a sensor, the sensor being configured to sense a signal, and wherein the automatic charging method comprises:
configuring to decide whether the automatic cleaning device enter an auto charging mode so as to sequentially perform a walking-along-the-wall operation and a reset charging operation;
during the walking-along-the-wall operation of the automatic cleaning device, when the sensor senses the signal, stopping the walking-along-the-wall operation, and performing the reset charging operation after the main body turns a preset angle; and
during the reset charging operation of the automatic cleaning device, after the main body moves to the charging base, determining whether the charging unit contacts a charging base, so as to charge the battery unit.

14. The automatic charging method according to claim 13, wherein the step of determining, during the reset charging operation of the automatic cleaning device and after the main body moves to the charging base, whether the charging unit contacts the charging base so as to charge the battery unit, comprises:
during the reset charging operation, when the automatic cleaning device senses that the charging unit does not contact the charging base, stopping the reset charging operation, and resuming the reset charging operation after the main body turns left and right.

15. The automatic charging method according to claim 14, wherein the automatic cleaning device performs the reset charging operation at most a preset number of times to determine at most the preset number of times whether the charging unit contacts the charging base, so that the automatic cleaning device decides whether to perform again the walking-along-the-wall operation.

16. The automatic charging method according to claim 15, wherein the preset number of times is four.

17. The automatic charging method according to claim 13, wherein during the walking-along-the-wall operation of the automatic cleaning device, the main body moves forward in a random direction until contacting a wall surface, so that the main body walks along the wall surface.

18. The automatic charging method according to claim 13, wherein the sensor is an infrared sensor, an ultrasonic sensor, a magnetic sensor or a laser sensor.
